(19) United States
(12) Patent Application Publication
(10) Pub. No.: US 2009/0024247 A1
(43) Pub. Date: Jan. 22, 2009

(54) Slip sensor

(76) Inventors: Christopher Scott Lovchik, Pearland, TX (US); Chris Rawls, League City, TX (US); Christopher G. Morlier, League City, TX (US)

Correspondence Address: TROP PRUNER & HU, PC, 1616 S. VOSS ROAD, SUITE 750, HOUSTON, TX, 77057-2631, US

(21) Appl. No.: 11/880,438

(22) Filed: Jul. 20, 2007

(51) Int. Cl. G01B 5/016; G06F 19/00; G01B 3/12

(52) U.S. Cl. 700/195; 700/13; 700/114; 33/711; 33/773

(57) ABSTRACT

In one embodiment, the present invention includes a sensor having a roller adapted on a shaft to roll along a workpiece surface, a compliant member adapted around at least a portion of the roller, and an encoder to code information regarding movement of the roller. In some implementations, the encoder may be in communication with a processor of a machine to provide information regarding workpiece movement.

### BACKGROUND

In many computer numerically controlled (CNC) machines, a workpiece is placed into the machine and is modified by operation of the machine, which may execute various instructions to provide a desired form to the workpiece using cutting tools, drilling tools, shaping tools and so forth. While many workpieces are formed of relatively rigid materials such as metals, woods and so forth, they can become deformed during machine operation.

Furthermore, when operated on in a CNC machine using a traction or other such drive system, workpiece slippage or drag may occur. Because of the automated and predetermined nature of the operations to be performed on the workpiece, such slippage, deformation or other excursions from a nominal position can negatively affect the results, particularly where finely controlled actions are needed. For example, in carving a design into a workpiece unintentional slippage or drag of the workpiece can cause a stairstep pattern or other undesirable result, or can cause damage or breakage of a tool. A need thus exists for improved manners of accurately determining workpiece positioning.

### BRIEF DESCRIPTION OF THE DRAWINGS

FIG. 1 is a plan view of a sensor in accordance with one embodiment.

FIG. 2 is a block diagram of an exploded view of a sensor in accordance with one embodiment of the present invention.

FIG. 3 is a block diagram of a sensor mounted in a machine in accordance with one embodiment of the present invention.

FIG. 4 is an overall view of a system in accordance with an embodiment of the present invention.

### SUMMARY OF THE INVENTION

In one embodiment, the present invention includes an apparatus having a roller adapted on a shaft to roll along a workpiece surface. The apparatus may include a compliant member adapted around at least a portion of the roller and an encoder to code information regarding movement of the roller. In one particular implementation, the compliant member may be a ring adapted about a portion of the roller to prevent slippage of the roller during movement along the workpiece. Further, the roller may have a textured profile to maintain a constant rolling diameter in contact with the workpiece. In some implementations, the encoder may be in communication with a processor of a machine to provide information regarding workpiece movement. In such a machine, the apparatus can be mounted between a pair of traction drives.

Yet another aspect of the present invention is directed to a method for contacting a roller of a sensor to a workpiece during operations in a processor controlled machine. The sensor, such as described above, may include a compliant member adapted around at least a portion of the roller and an encoder to code information regarding movement of the roller. The method may further include communicating information regarding movement of the roller to a processor of the machine, and controlling operation of a tool assembly of the machine based on the information. In this way, movement of the tool assembly may be updated to account for slippage and/or warpage of the workpiece.

A still further aspect of the present invention is directed to a processor controlled workpiece modifying machine having a tool assembly to support a tool and provide for movement of the tool, a support structure to support a workpiece and provide for movement of the workpiece along a first axis via first and second drive members, and a sensor coupled between the first and second drive members. The sensor may have a roller adapted on a shaft to roll along a workpiece surface, a compliant member adapted around at least a portion of the roller and an encoder to code information regarding movement of the roller.

### DETAILED DESCRIPTION

In various embodiments, a sensor may be provided to compensate for slip or drag on a workpiece that is being fed through a CNC machine using a drive system such as a traction drive. The sensor may be designed to accurately measure the workpiece regardless of its hardness or surface texture. Furthermore, the sensor may be designed to handle deformation (e.g., warp or bow) in the workpiece, as well as to operate properly in dirty environments, as actions performed on the workpiece can cause considerable debris, waste and other particulate matter. Still further, embodiments may provide a sensor able to handle any vibration induced into the workpiece by the machine.

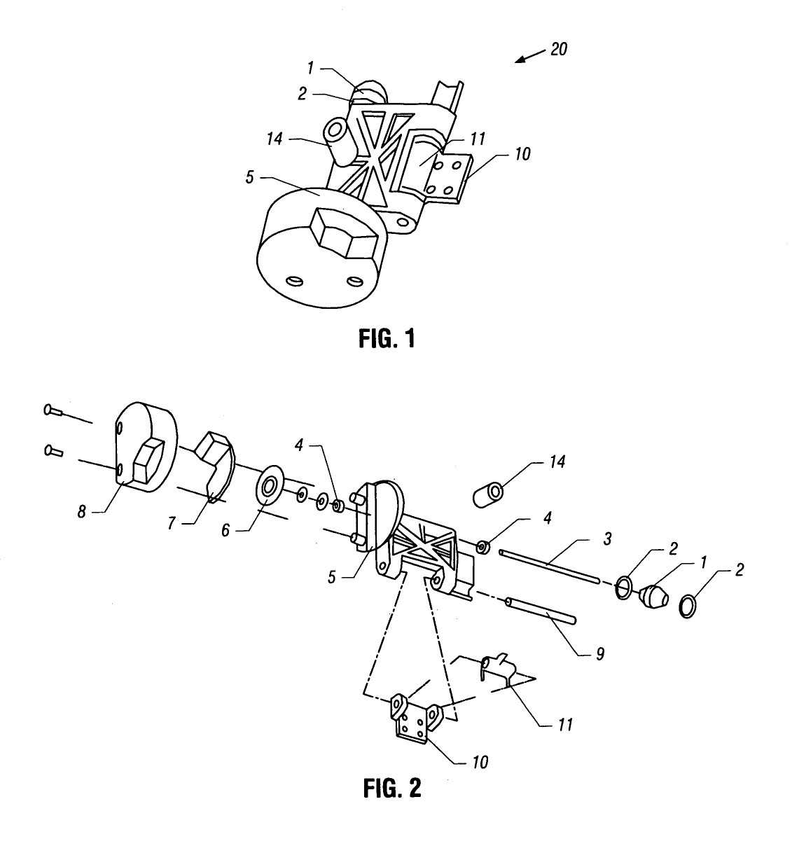

Referring now to FIG. 1, shown is a plan view of a sensor in accordance with one embodiment. As shown in FIG. 1, sensor 20 has a main structure 5 that houses an encoder and which is pivotally mounted to a mounting plate 10 and spring loaded with a torsion spring 11. A rigid textured roller 1 combined with a compliant member 2 may roll along a workpiece during operation to, in effect, read a surface of the workpiece. As further shown in FIG. 1, a damper 14 may be mounted to the underside of main structure 5.

The hard textured surface of the roller 1 may thus maintain a constant rolling diameter in contact with the workpiece. Such a constant diameter may thus maintain accurate measurement of the workpiece. The texture of roller 1 is primarily to assist with its traction. In some embodiments, roller 1 may be formed of a relatively rigid metal such as brass, copper, or so forth. The texturing can vary. For example, in one embodiment the texture may be in the form of a toothed belt profile. In this way, jigs that have a matching tooth profile along their length can be used in the machine. Furthermore, texturing may provide the ability to work on very small parts as well as very provide high precision positioning.

Compliant member 2, which may be formed of a relatively soft material such as rubber, or the like, may keep roller 1 from slipping on hard or slick surfacing. Different positioning and implementation of compliant member 2 may occur in various embodiments. For example, a single member may be present and adapted rearward of a forward-facing portion of roller 1. Alternately, a single member may be adapted on the forward-facing portion. Still further, multiple members may be present, one on a forward portion and one on a rearward portion of roller 1. Note that compliant member 2 may help to reduce vibration-induced errors, however, it should be compliant enough so that the hard textured surface of roller 1 maintains contact with the workpiece. In one embodiment, compliant member 2 may be an O-ring or similar ring-like structure.

FIG. 2 shows an exploded view of sensor 20. In operation, sensor 20 uses rigid textured roller 1 combined with a pair of compliant members 2, all of which are mounted to a shaft 3 and riding in bearing 4 through an opening in main structure 5. An encoder disk 6 is mounted to the end of shaft 3 opposite roller 1. An encoder reader 7 is mounted within main structure 5 to read encoder disk 6. Encoder disk 6 may include indentations around its periphery that can be read by encoder reader 7. In one embodiment, encoder disk 6 may include a predetermined number of indentations, such that each indentation corresponds to a given amount of workpiece travel. The entire encoder assembly may be encased within a cover 8 to keep dust from interfering with the function of the sensor. As further shown in FIG. 2, main structure 5 is pivotal on a shaft 9 and spring loaded to mounting plate 10 with torsion spring 11. Damper 14 is mounted to the underside of sensor 20.

While the scope of the present invention is not so limited, embodiments may be implemented in a processor-controlled carving machine such as that detailed in U.S. Pat. Nos. 6,859,988 and 7,140,089, commonly assigned with the current application, and the disclosures of which are hereby incorporated by reference.

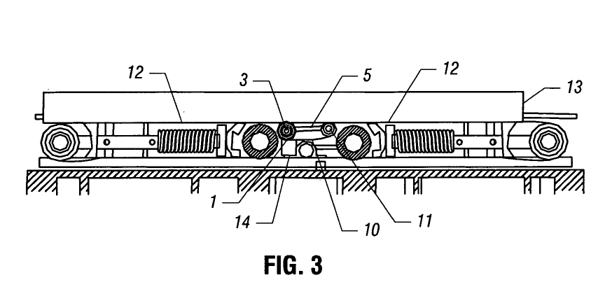

FIG. 3 shows the sensor mounted in a machine. The sensor is located in the machine between a pair of traction drives 12 and is offset from the center to provide clearance for a cutting bit or other tool in a tool assembly of the machine. The mounting bracket 10 is attached to the machine so that roller 1 is loaded by the torsion spring 11 against the underside of a workpiece 13. As shown in FIG. 3, damper 14 is mounted to the underside of the sensor assembly so that it provides pressure between the machine and the sensor main structure 5.

Thus as shown in FIG. 3, the sensor assembly is pivotally mounted and spring loaded against workpiece 13, allowing it to travel up and down by riding most deformations in the workpiece. In one embodiment, the pivot may be set so that in the nominally loaded position it is in line horizontally with shaft 3 that supports roller 1. This configuration provides the largest vertical range (to handle a warped or bowed workpiece) with the least error in measurement. The loading of the sensor can be done in a number of ways. As shown in FIG. 3, in one embodiment, roller 1 is spring loaded against workpiece 13 with torsion spring 11, with damper 14 located under the shaft 3 to eliminate errors due to high frequency vibrations in workpiece 13.

While not shown in FIG. 3, a communication channel between the sensor assembly and a main processor such as a central processing unit (CPU) or other controller of a machine may be present. In some embodiments, dedicated wires extending from encoder reader 6 may be coupled to the processor via a motherboard or other substrate on which the processor is adapted. Alternately, a wireless interface to provide for wireless communication between the sensor and the processor may be present. In any event, position information regarding workpiece movement may be provided from the sensor assembly to the processor. In turn, the processor may use the information to update tool action based on actual workpiece movement. In this way, errors such as stairstep errors or other errors caused by slippage or other undesired movement of a workpiece can be avoided.

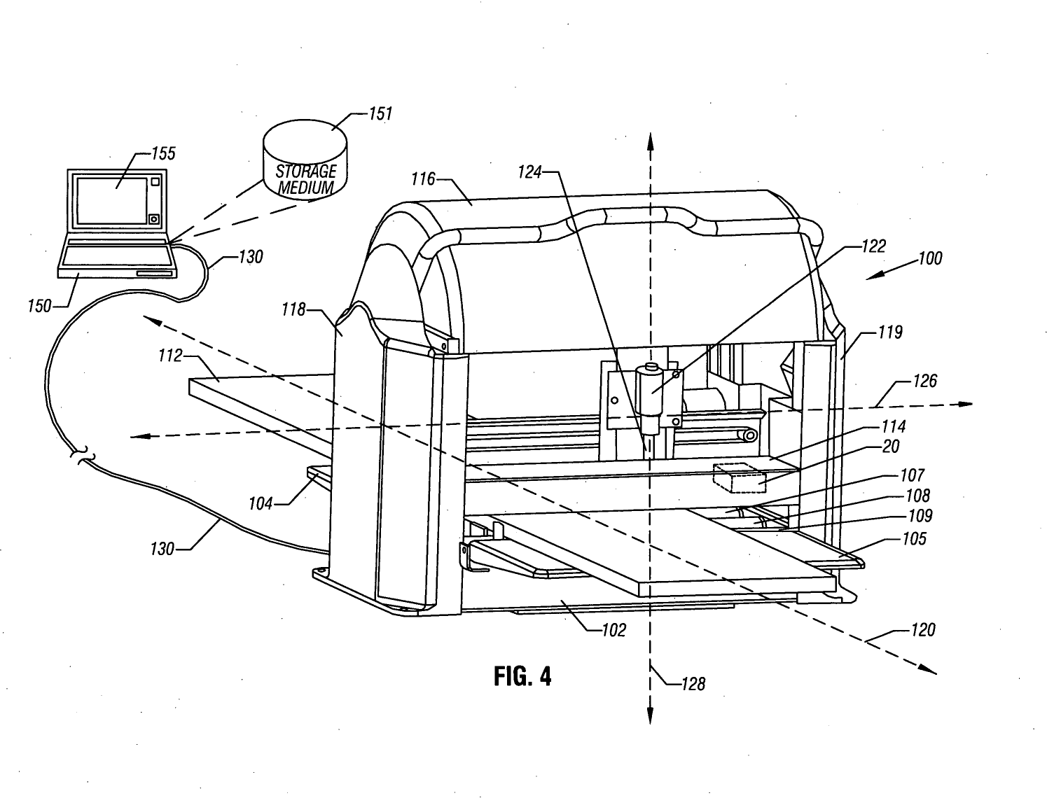

Note the cross-section view of FIG. 3 is in simplified form to show relevant portions of the machine and its interaction with the sensor assembly. Referring now to FIG. 4, shown is an overall view of a system in accordance with an embodiment, in which the sensor's position is identified in phantom by the reference numeral 20 in the overall view. As shown in FIG. 4, a processor controlled machine 100 includes a base 102, feed trays 104 and 105, and lower rollers 107 and 109 (one lower roller obscured in FIG. 4) that together form a horizontal surface that supports and horizontally translates a workpiece 112, a head assembly 114, and top 116 and side 118, 119 covers that cover an internal frame that supports the head assembly 114 in a position above the workpiece 112. The head assembly 114 includes two clamping rollers (not shown in FIG. 4) that clamp the workpiece 112 between the clamping rollers and lower rollers 107, 109. Sensor 20 may be adapted to a support surface located between the lower rollers 107, 109 and a second set of lower rollers (not shown in FIG. 4). The lower rollers are motor driven to translate the workpiece 112 both forward and backward in a horizontal, or x, direction 120. The head assembly 114 includes a cutting head assembly 122 that includes a bit adapter 124 that holds a drilling, cutting, shaping, routing, or other type of tool that is rotated and that is positioned onto, and moved across and into, the workpiece 112 in order to carve and shape the workpiece. The head assembly 114 includes lateral and vertical translation means to translate, under processor control, the cutting head assembly 122 in a lateral, or y, direction 126 and in a vertical, or z, direction 128, respectively.

Processor control of the cutting head assembly 122 in the y and z directions 126 and 128, and processor control of the workpiece 112 in the x direction 120, allows for arbitrary positioning of the cutting, drilling, shaping, routing, or other tool with respect to the workpiece 112 and for moving the drilling, cutting, shaping, routing, or other bit in arbitrary straight-lines, 2-dimensional curves, across 2-dimensional surfaces arbitrarily oriented in three dimensions, and in 3-dimensional curves in order to drill, cut, shape, and rout the workpiece in an almost limitless number of ways.

Sensor 20 may thus communicate movement of the workpiece 112 to the processor. Other sensors may also communicate information regarding the positions and shapes of the workpiece 112. For example, the machine may include a load-sensing sensor that can sense and report to the processor the speed of the motor driving the rotation of the cutting head, so that the machine can adjust the weight of the workpiece and cutting-head assembly translation in order to maintain a relatively even load on a drilling, cutting, routing, shaping, or other type of bit.

The processor controller may be connected to a host PC or other computer system via a computer-connection cable 130. The processor is responsible for real-time control of the machine and for stand-alone control of the machine. In many applications, overall control of the machine may be the responsibility of a host computer system, such as host personal computer 150, interconnected with the processor via the computer-connection cable 130, shown in FIG. 4. The processor may thus monitor environmental inputs from various sensors included in the machine, which may include sensors to detect the shape and position of the workpiece, the load on the cutting head, temperature of various positions and of various components of the machine, and other sensors. The host PC 150 may generate command sequences based on stored designs, templates, and directives generated partially or completely as a result of interaction of a human user with the host PC 150, and transmits the commands to the processor, which then controls the components to effect each command. The processor facilitates safe operation of the machine by sensing, via various sensors embedded in the machine unsafe conditions, and shutting down one or more components, such as the motors driving rotation of the cutting head and translation of the workpiece and cutting-head assembly, to prevent catastrophic failures. The processor may include or be coupled to memory to store a variety of command sequences to allow for a command-based, stand-alone operation initiated and directed by a user through a control panel independent of host PC 150. The host PC 150 provides a GUI 155 that allows a user to draw, or compose, designs and templates reflecting an almost limitless number of combinations of elementary operations defined by a combination of a particular drilling, cutting, routing, shaping, or other bit with positions, lines, and curves. As shown in FIG. 4, a computer-readable storage medium 151 (schematically shown) may be coupled to host computer 150. Alternately, the machine may include one or more ports to receive removable storage media, to download one or more sets of instruction to control execution of operations on the machine.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a roller adapted on a shaft, the roller to roll along a surface of a workpiece located in a machine;
a compliant member adapted around at least a portion of the roller; and
an encoder to code information regarding movement of the roller.

2. The apparatus of claim 1, wherein the compliant member comprises a ring about a portion of the roller, wherein the ring is to prevent slippage of the roller during movement along the workpiece.

3. The apparatus of claim 1, wherein the roller comprises a textured profile to maintain a constant rolling diameter in contact with the workpiece.

4. The apparatus of claim 1, wherein the encoder is in communication with a processor of the machine to provide information regarding workpiece movement.

5. The apparatus of claim 4, wherein the machine comprises a processor controlled workpiece modifying machine.

6. The apparatus of claim 5, wherein the apparatus is mounted between a first traction drive and a second traction drive of the processor controlled workpiece modifying machine.

7. The apparatus of claim 4, wherein the encoder includes an encoder disk mounted on the shaft and a reader to read the encoder disk and generate the information therefrom.

8. The apparatus of claim 1, further comprising:
a bracket having a first aperture to receive the shaft and a second aperture to receive a second shaft;
a mounting plate to be mounted to a support surface of the machine and having an opening through which the second shaft is extended; and
a torsion spring coupled about the second shaft to pivotally adapt the bracket to the mounting plate.

9. The apparatus of claim 8, wherein the torsion spring is to load the roller to an underside of the workpiece.

10. The apparatus of claim 8, wherein the apparatus is mounted to be offset in a first direction from a tool assembly of the machine.

11. The apparatus of claim 8, further comprising a damper coupled between the torsion spring and the bracket.

12. The apparatus of claim 1, further comprising a second compliant member adapted around a forward portion of the roller, wherein the compliant member is adapted around a rearward portion of the roller.

13. A method comprising:
contacting a roller of a sensor to a workpiece during operations in a processor controlled machine, the sensor including a compliant member adapted around at least a portion of the roller and an encoder to code information regarding movement of the roller;
communicating information regarding movement of the roller to a processor of the processor controlled machine; and
controlling operation of a tool assembly of the processor controlled machine based on the information.

14. The method of claim 13, wherein controlling the operation comprises updating movement of the tool assembly to account for slippage of the workpiece.

15. The method of claim 13, wherein controlling the operation comprises updating movement of the tool assembly to account for warpage of the workpiece.

16. A processor controlled workpiece modifying machine comprising:
a tool assembly to support a tool and provide for movement of the tool;
a support structure to support a workpiece and provide for movement of the workpiece along a first axis via a first drive member and a second drive member; and
a sensor coupled between the first drive member and the second drive member, the sensor including a roller adapted on a shaft to contact the workpiece during operation, a compliant member adapted around at least a portion of the roller to contact the workpiece during operation, and an encoder to code information regarding movement of the roller.

17. The processor controlled workpiece modifying machine of claim 16, wherein the encoder includes an encoder disk mounted on the shaft and a reader to read the encoder disk and generate the information therefrom.

18. The processor controlled workpiece modifying machine of claim 16, further comprising a bracket having a first aperture to receive the shaft and a second aperture to receive a second shaft, a mounting plate to be mounted to the support structure and having an opening through which the second shaft is extended, and a torsion spring coupled about the second shaft to pivotally adapt the bracket to the mounting plate.

19. The processor controlled workpiece modifying machine of claim 18, further comprising a damper coupled between the torsion spring and the bracket and a second compliant member adapted around a forward portion of the roller, wherein the compliant member is adapted around a rearward portion of the roller.
